(19) United States
(12) Patent Application Publication
(10) Pub. No.: US 2020/0196125 A1
(43) Pub. Date: Jun. 18, 2020

(54) METHOD AND SERVER TO PROVIDE PERIODIC UPDATES TO CITIZENS

(71) Applicant: MOTOROLA SOLUTIONS, INC, Chicago, IL (US)

(72) Inventors: FRANCESCA SCHULER, PALATINE, IL (US); SALENA SOMANI, CHICAGO, IL (US); RANDY L. EKL, DOWNERS GROVE, IL (US); SHWETAL S. PARIKH, PALATINE, IL (US)

(21) Appl. No.: 16/221,919

(22) Filed: Dec. 17, 2018

(51) Int. Cl. H04W 4/90; H04M 3/51; H04W 4/06; H04W 12/00; H04L 29/06

(52) U.S. Cl. CPC H04W 4/90; H04M 3/5116; H04L 63/0421; H04W 12/001; H04W 4/06

(57) ABSTRACT

A method and update server provide periodic updates to citizens in an update group. The update server receives incident information relating to an incident. The incident information is stored by the update server. The update server determines a narrative for the incident information by redacting any sensitive or confidential information to produce a redacted incident report. The update server also determines a cadence related to the incident, which is the frequency of how often the information will be sent to the update group. At the appropriate time, the update server sends the redacted incident report to the update group.

### BACKGROUND OF THE INVENTION

Public safety benefits from calls from citizens relating to an incident. These calls can interface with public safety via a 911 call, a 311 call, a tip line, or any other electronic communication to a public safety officer or dispatcher.

Citizens who provide this incident related information typically are not kept apprised of updates to the incidents. This can lead to a disconnected feeling for the citizen, which could lead the citizen to not report an incident in the future. This leads to a situation where public safety professionals do not receive information that could be helpful in working on an incident, which can lead to more unsafe communities and potentially put public safety officers at risk.

Therefore a need exists for a way of keeping citizens who report on an incident informed of the progress of the incident.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a communication system in accordance with an exemplary embodiment of the present invention.

FIG. 2 depicts a schematic of an update server in accordance with an exemplary embodiment of the present invention.

FIG. 3 depicts a flowchart in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An exemplary embodiment provides a method of distributing periodic updates to interested parties who have contacted 311, 911, or a tip line regarding a specific request, tip, or incident. The exemplary embodiment provides updates both in real-time (during the incident), and also post incident. A group related to a specific incident is preferably created upon incident creation. If a person desires to receive updates about the incident, the person can subscribe to the group. The update server determines the content, narrative, and timing of the updates and provides the updates to the members of the update group. In an exemplary embodiment, the content, narrative, and timing of the updates varies based upon whether the incident is open or closed. A group member can also decide to unsubscribe from the update group if the member no longer desires to receive updates regarding the related incident.

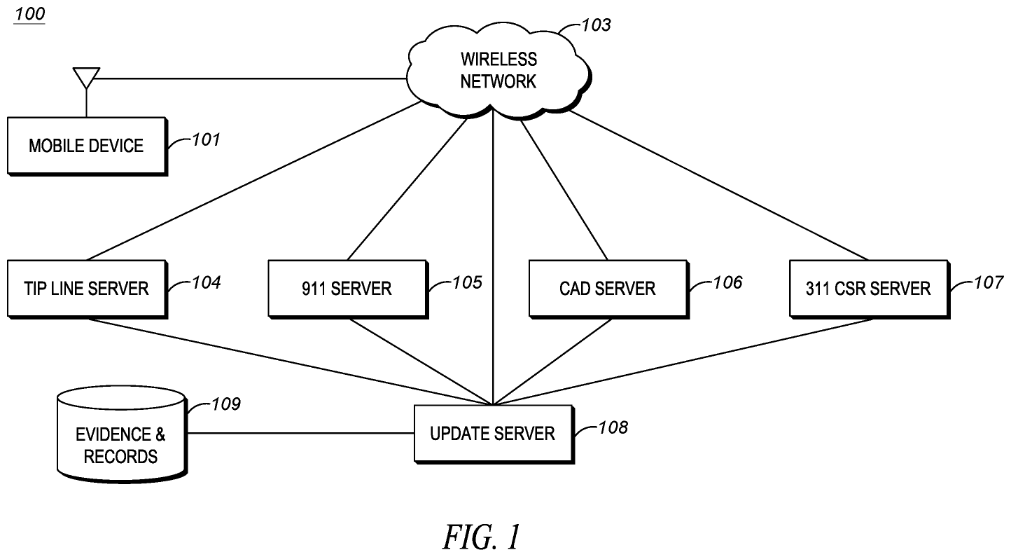

FIG. 1 depicts a system diagram of a communication system 100 in accordance with an exemplary embodiment of the present invention. Communication system 100 preferably includes mobile device 101, Wireless Network 103, Tip Line Server 104, 911 Server 105, CAD Server 106, 311 CSR Server 107, Update Server 108, and Evidence and Records Database 109. In this embodiment, mobile device 101 is connected to Wireless Network 103. It should be understood that communication system 100 would typically include may more mobile devices, but only one, mobile device 101 is included for clarity.

Mobile device 101 is operably connected to Wireless Network 103 and is preferably a telephone that can make and receive calls over a radio frequency link while the user is moving within a telephone service area served by Wireless Network 103. Mobile device 101 could alternately be any communication device that can communicate with a network and provide or receive information about an incident. Such alternate mobile devices could be computers, landline telephones, two-way radios, etc.

Wireless Network 103 is a network that provides wireless communications for subscribers such as mobile device 101. Wireless Network 103 is preferably coupled to Tip Line Server 104, 911 Server 105, CAD Server 106, 311 CSR Server 107, and Update Server 108 In an exemplary embodiment, Wireless Network 103 is an LTE network. A core network within the LTE network handles overall control of communication devices within Wireless Network 103. The core network typically comprises a PDN Gateway (P-GW), a Serving Gateway (S-GW), a Mobility Management Entity (MME), a Home Subscriber Server (HSS), and the Policy Control and Charging Rules Function (PCRF). An access network of LTE, commonly referred to as E-UTRAN, typically comprises a network of eNodeBs, not shown for clarity purposes.

Tip Line Server 104 is a server that receives information about crimes or other public safety incidents. Tips are preferably submitted via telephone, email, or other social media outlets. The phone that receives tips is typically a standalone device that does not include features that could be used to identify the caller. In addition, the phone that receives tips is typically not provided with any hardware or software that could record the conversations received. In this manner, the anonymity of the caller is preserved. The caller typically provides information about the incident to the call recipient, who passes the information received to a public safety officer. The information received is entered into a database or the like and is given a tip number, which is shared with the caller.

911 Server 105 is a server that receives emergency calls from members of the public. 911 Server 105 receives calls, preferably from callers who dial an emergency number such as 9-1-1. Dialing 9-1-1 from any telephone in the United States connects the caller with a Public Safety Answering Point (PSAP). The dispatcher who answers these emergency calls can send emergency responders to the reported incident and, in enhanced systems, can pair the caller with a physical address.

CAD Server 106 is a server that assists dispatch personnel and emergency operators in handling and prioritizing emergency calls. Enhanced 911 systems send the location of the caller to CAD 111, which automatically displays the address of the 911 caller on a screen in front of the emergency operator. The CAD operator in a dispatch center can easily view the status of all units dispatched to an incident scene.

311 CSR (Customer Service Request) Server 107 is a server that receives non-emergency calls. 311 CSR Server 107 is similar to 911 Server 105.

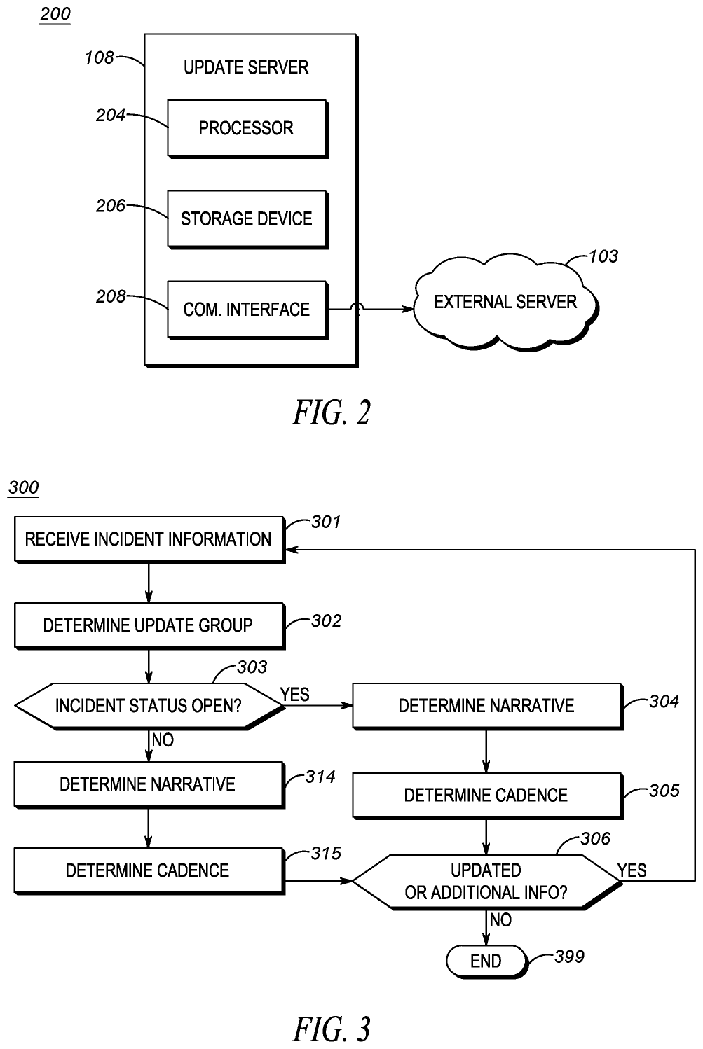

Update Server 108 is a server that is described in more detail in FIG. 2. Update Server 108 receives incident information and determines an update group that this incident information relates to. Update Server 108 also determines a narrative and a cadence for the update information, such that the proper information is transmitted to the update group at the proper times. The proper information could include the incident information with sensitive information, such as names, dates of birth, and social security numbers, redacted.

Evidence and Records Database 109 is a database that stores the incident information for the update groups. Evidence and Records Database 109 is preferably a database with communication system 100, but can alternately be cloud-based storage.

CAD 111 is a computer system that assists dispatch personnel and emergency operators, such as 911 operators, in handling and prioritizing emergency calls. In addition, Enhanced 911 systems send the location of the caller to CAD 111, which automatically displays the address of the 911 caller on a screen in front of the emergency operator.

Complaint information can be entered into CAD 111 and can be easily retrieved. Utilizing CAD 111, operators in a dispatch center are able to easily view and understand the status of all units being dispatched. CAD 111 provides displays and tools so that the dispatcher and other emergency personnel have an opportunity to handle emergency calls as efficiently as possible.

FIG. 2 schematically illustrates Update Server 108 in more detail. In the exemplary embodiment depicted in FIG. 2, Update Server 108 includes an electronic processor 204, a storage device 206, and a communication interface 208. Electronic processor 204, storage device 206, and communication interface 208 communicate over one or more communication lines or buses. Wireless connections or a combination of wired and wireless connections are also possible.

Electronic processor 204 may include a microprocessor, application-specific integrated circuit (ASIC), field-programmable gate array, or another suitable electronic device. Electronic processor 204 obtains and provides information (for example, from storage device 206 and/or communication interface 208), and processes the information by executing one or more software instructions or modules, capable of being stored, for example, in a random access memory (“RAM”) area of storage device 206 or a read only memory (“ROM”) of storage device 206 or another non-transitory computer readable medium (not shown). The software can include firmware, one or more applications, program data, filters, rules, one or more program modules, and other executable instructions. Electronic processor 204 is configured to retrieve from storage device 206 and execute, among other things, software related to the control processes and methods described herein.

Storage device 206 can include one or more non-transitory computer-readable media, and may include a program storage area and a data storage area. The program storage area and the data storage area can include combinations of different types of memory, as described herein. In the embodiment illustrated, storage device 206 stores, among other things, instructions for the processor to carry out the method of FIG. 3.

Communication interface 208 may include a transceiver (for example, an LTE modem, an FM transceiver, or a Wi-Fi or Ethernet transceiver) for communicating with an external server 103, which in an exemplary embodiment can be Tip Line Server 104, 911 Server 105, CAD Server 106, or 311 CSR Server 107. Communication interface 208 can also communicate with communication networks, such as Wireless Network 103.

FIG. 3 depicts a flowchart 300 of a method for providing periodic updates to citizens regarding an incident, such as a public safety incident, in accordance with an exemplary embodiment of the present invention. The update subscribers can also choose to unsubscribe from the group at any time, in which case they would no longer receive the periodic updates.

Update Server 108 receives (301) incident information. In accordance with an exemplary embodiment, the trigger for receiving the incident information is a call to a public safety dispatcher, such as a 911 call, a 311 call, or a public tip line. The information is preferably stored in a public safety database. Upon receiving the incident information, the dispatcher or the like preferably determines the incident type, the incident location, and whether the received information relates to a known incident or an existing incident.

Update Server 108 determines an update group for this incident. The update group can include any combination of 911 callers, 311 callers, tip line callers, or any member of the public who would like to receive periodic updates relating to the incident. Callers or members of the public can preferably join or leave the update group at any time, whether pre-incident, mid-incident, or post-incident. A pre-incident can be, for example, one or more citizens noticing suspicious activity that a responder is asked to check out. A further example of a pre-incident is activity before a public safety officer arrives. In accordance with an exemplary embodiment, interested group members can also can select which types of incidents they are interested in getting updates for, based on type, location, or other factors. Callers are preferably asked if they would like to join an update group upon conveying the information they have about the incident. Each update group is preferably identified by a specific incident ID.

Update Server 108 determines (303) if the specified incident is open. An incident is considered open if it is mid-incident and currently being processed. This determination preferably helps determine a different cadence and narrative for any updates provided.

If the incident specified is open as determined at step 303, Update Server 108 determines (304) a narrative for the incident. In accordance with an exemplary embodiment, the narrative includes content that is added to the narrative based upon how well the source providing the content is trusted. In accordance with an exemplary embodiment, the content is redacted to remove any sensitive material from the narrative, since the recipients of the narrative are typically not public safety officers but rather members of the general public. For example, names of suspects, witnesses, and public safety officers can be redacted prior to adding the content to the narrative.

Update Server 108 determines (305) the cadence of incident status updates. In an exemplary embodiment, the cadence, or timing, of incident status updates is determined by the number of call updates, the timing distribution of call updates, the unique number of callers, the caller trust factor, the content trust factor, the time since incident, the type of incident, the severity of incident, and/or the current status of incident.

If the incident specified is not open, which means that the incident has been closed, as determined at step 303, Update Server 108 determines (314) a narrative for the incident. In accordance with an exemplary embodiment, the narrative includes content that is added to the narrative based upon how well the source providing the content is trusted. In accordance with an exemplary embodiment, the content is redacted to remove any sensitive material from the narrative, since the recipients of the narrative are typically not public safety officers but rather members of the general public. For example, names of suspects, witnesses, and public safety officers can be redacted prior to adding the content to the narrative.

Update Server 108 determines (315) the cadence of incident status updates. In an exemplary embodiment, the cadence, or timing, of incident status updates is determined by the number of call updates, the timing distribution of call updates, the unique number of callers, the caller trust factor, the content trust factor, the time since incident, the type of incident, the severity of incident, and/or the current status of incident.

Whether the incident status is open or not, both scenarios end up determining (306) whether the caller has updated or additional information to add to the incident record. If the caller does have additional or updated information, the process returns to step 301 to rerun the steps of FIG. 3. This allows civilians to provide updates, which can in turn drive changes to the narrative. If the caller does not have additional or updated information, the process ends (399).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving incident information relating to an incident at the update server, the incident information received from a source;
storing the incident information in a public safety database;
determining an update group related to the incident at the update server;
determining a narrative related to the incident at the update server, the narrative including content that is added to the narrative based upon how well the source is trusted by the update server; and
determining a cadence related to the incident at the update server.

2. The method of claim 1, wherein the step of determining a narrative related to the incident at the update server comprises producing a redacted incident report at the update server, and wherein the redacted incident report comprises the narrative with sensitive material removed.

3. The method of claim 2, the method further comprising the step of sending the redacted incident report to the update group by the update server.

4. The method of claim 3, the method further comprising the step of sending the redacted incident report to the update group at the determined cadence by the update server.

5. The method of claim 1, the method further comprising the step of receiving a request for the incident information at the update server. and wherein the request includes a group ID of the update group.

6. The method of claim 1, wherein the step of receiving incident information comprises receiving incident information via a 911 service at the update server.

7. The method of claim 1, wherein the step of receiving incident information comprises receiving incident information via a 311 service at the update server.

8. The method of claim 1, wherein the step of receiving incident information comprises receiving incident information at the update server via a tip line.

9. An electronic update server comprising:
an electronic communication interface; and
an electronic processor that performs:
receiving incident information relating to an incident, the incident information received from a source;
storing the incident information in a storage device;
determining an update group related to the incident;
determining a narrative related to the incident, the narrative including content that is added to the narrative based upon how well the source is trusted by the update server; and
determining a cadence related to the incident.

10. The electronic update server of claim 9, wherein the step of determining a narrative related to the incident in the processor comprises producing a redacted incident report comprising the narrative with sensitive material removed.

11. The electronic update server of claim 10, wherein the processor further performs the step of electronically sending the redacted incident report to the update group.

12. The electronic update server of claim 11, wherein the processor further performs the step of electronically sending the redacted incident report to the update group at the determined cadence.

13. The electronic update server of claim 9, wherein the processor further performs the step of electronically receiving a request for the incident information. and wherein the request includes a group ID of the update group.

14. The electronic update server of claim 9, wherein the step of receiving incident information relating to an incident in the processor comprises receiving incident information via a 911 service.

15. The electronic method of claim 9, wherein the step of receiving incident information relating to an incident in the processor comprises receiving incident information via a 311 service.

16. The electronic method of claim 9, wherein the step of receiving incident information relating to an incident in the processor comprises receiving incident information via a tip line.
